(19) United States
(12) Patent Application Publication
(10) Pub. No.: US 2006/0173748 A1
(43) Pub. Date: Aug. 3, 2006

(54) Method and system of processing missing orders in E-commerce

(75) Inventors: Zechary Chang, Taipei (TW); Iris Yang, Beijing (CN)

Correspondence Address: BIRCH STEWART KOLASCH & BIRCH, PO BOX 747, FALLS CHURCH, VA, 22040-0747, US

(73) Assignee: INVENTEC CORPORATION

(21) Appl. No.: 11/048,912

(22) Filed: Feb. 3, 2005

(51) Int. Cl. G06Q 30/00

(52) U.S. Cl. 705/26

(57) ABSTRACT

A method and a system of processing missing orders in E-commerce are disclosed to exchange trading message among the buyers, the payment platform, and the seller and to immediately find out any missing order. The payment platform includes a back-stage procedure, which is automatically executed regularly to compare a merchandise delivery list and a payment list, thereby generating a missing order message. The missing order message is transmitted to the corresponding seller until the payment platform receives information regarding merchandise delivery sent from the seller.

### BACKGROUND OF THE INVENTION

1. Field of Invention

The invention relates to an E-commerce method and, in particular, to a method of processing missing order in E-commerce and the system thereof.

2. Related Art

In recent years, the rapid development of World Wide Web (WWW) has brought us many E-commerce trading websites that provide people with merchandises and services. A lot of pioneers who see the future of web business have been joining and contributing to the field.

The Internet age completely overturn the traditional trading mechanism of “cash on delivery.” Through the sale model of E-commerce, consumers browse web pages to analyze and decide what to purchase. Consumers can have real-time and in-depth communications regarding the contents. However, due to the virtual character of the E-commerce, Internet shops have to ensure the accuracy and speed of trading information exchange in order to eliminate any unease of the consumers. However, the correctness of trades relies much on the normal operation of the network between the seller and the payment platform. If anything unusual happens to the computer system and the network, the buyer's payment information cannot be corrected transmitted to and displayed on the seller's system. This will result in missing orders. As a consequence, the seller will not deliver the merchandise to the buyer in time or at all. The buyer will thus have unhappy experience with the seller, which greatly affects the reputation of the seller.

### SUMMARY OF THE INVENTION

In view of the foregoing, an objective of the invention is to provide a method and a system of processing missing orders in E-commerce. By checking the payment and merchandise delivery information in real time, any missing order can be found out rapidly and therefore be remedied. The seller can thus deliver the merchandises that are already been paid.

To achieve the above objective, the disclosed method of processing missing orders in E-commerce transmits trading messages among the buyer, the payment platform, and the seller on the Internet. The buyer pays via the payment platform and obtains the merchandise delivery authorization from the seller. The steps include: receiving payment information; transmitting the payment information to the corresponding seller and storing it in a payment list; receiving merchandise delivery authorization information sent from the seller and storing it to a merchandise delivery authorization list; starting a back-stage procedure to compare the merchandise delivery authorization list with the payment list to generate a missing order message and transmitting the missing order message to the corresponding seller; receiving the awaiting merchandise delivery authorization information sent from the corresponding seller and storing it to the merchandise delivery authorization list. The payment platform automatically starts the back-stage procedure regularly.

Along with the above-mentioned method, the invention further discloses a system of processing missing orders in E-commerce to transmit trading messages among the buyer, the payment platform and the seller on the Internet. It is featured in that the payment platform includes a back-stage procedure comparing the payment list and the merchandise delivery authorization list to generate a missing order message. The missing order message is further transmitted to the corresponding seller until the awaiting merchandise delivery authorization information from the seller is received.

### BRIEF DESCRIPTION OF THE DRAWINGS

The invention will become more fully understood from the detailed description given hereinbelow illustration only, and thus are not limitative of the present invention, and wherein:

FIG. 1 is a schematic view of the disclosed system; and

FIG. 2 is a flowchart of the disclosed method.

### DETAILED DESCRIPTION OF THE INVENTION

The disclosed method and system of processing missing orders in E-commerce are used in E-commerce websites on the Internet. A payment platform is used to transmit messages among a plurality of buyers and sellers and to check and amend missing orders regularly.

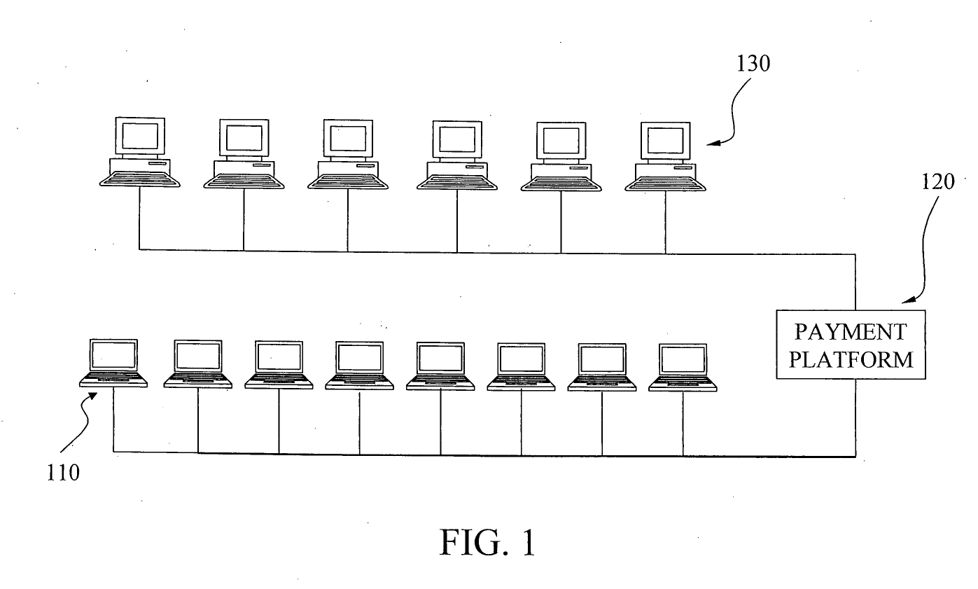

As shown in FIG. 1, the disclosed system has several buyer operating terminals 110, several seller operating terminals 130, and a payment platform 120. The buyer operating terminals 110 and the seller operating terminals 130 exchange messages via the Internet (not shown) and the payment platform 120. The buy operating terminal 110 makes a payment on the payment platform 120 and transmits the payment message to the corresponding seller operating terminal 130. The payment message is stored in a payment list. The payment platform receives merchandise delivery authorization information sent from the seller operating terminal 130. The merchandise delivery authorization information is stored in a merchandise delivery authorization list. The payment platform 120 includes a back-stage procedure comparing the payment list and the merchandise delivery authorization list to generate a missing order message. The missing order message is further transmitted to the corresponding seller until the awaiting merchandise delivery authorization information from the seller is received.

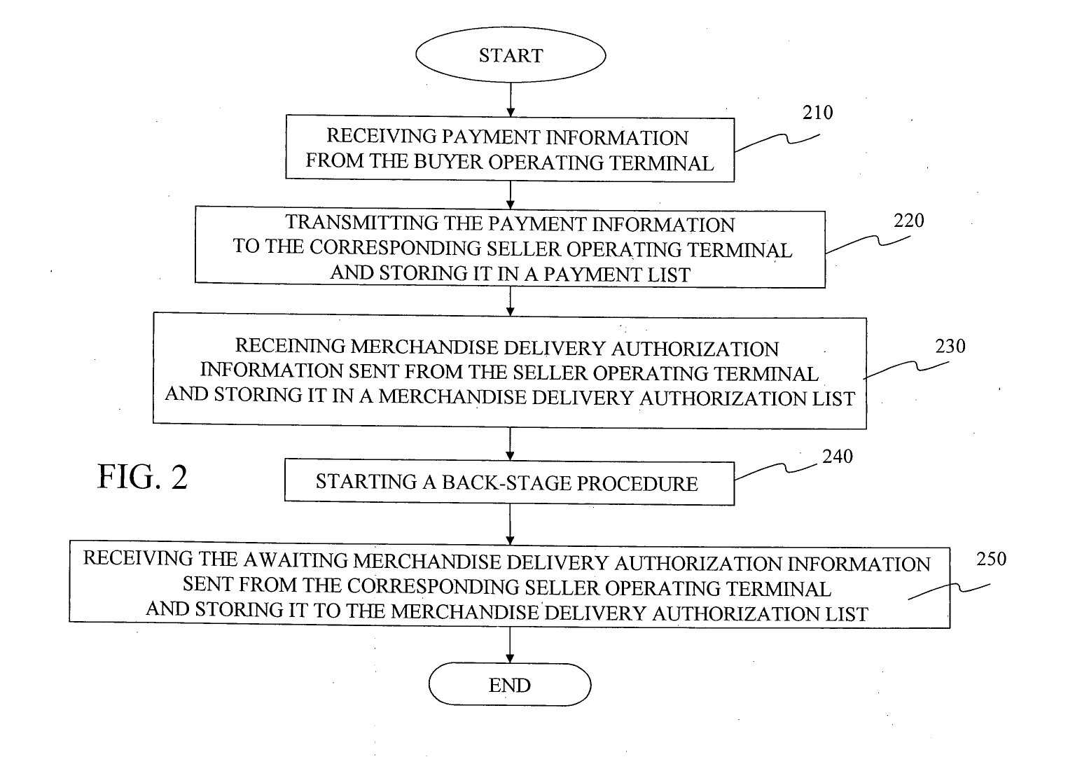

The disclosed method of processing missing orders in E-commerce is executed by the above-mentioned system on the payment platform. As shown in FIG. 2, the steps of the method are: receiving payment information from the buyer operating terminal (step 210); transmitting the payment information to the corresponding seller operating terminal and storing it in a payment list (step 220); receiving merchandise delivery authorization information sent from the seller operating terminal and storing it to a merchandise delivery authorization list (step 230); starting a back-stage procedure to compare the merchandise delivery authorization list with the payment list to generate a missing order message and transmitting the missing order message to the corresponding seller operating terminal (step 240); receiving the awaiting merchandise delivery authorization information sent from the corresponding seller operating terminal and storing it to the merchandise delivery authorization list (step 250).

The step of receiving merchandise delivery authorization information sent from the seller operating terminal and storing it to a merchandise delivery authorization list can further include the step of displaying a successful trade message on the buyer operating terminal. Likewise, the step of receiving the awaiting merchandise delivery authorization information sent from the corresponding seller operating terminal after starting the back-stage procedure can include displaying a successful trade message on the buyer operating terminal.

Certain variations would be apparent to those skilled in the art, which variations are considered within the spirit and scope of the claimed invention.

What is claimed is:

1. A method of processing missing orders in E-commerce for transmitting trading messages among a plurality of buyers, a payment platform, and a plurality of sellers on the Internet, comprising the steps of:
receiving payment information;
transmitting the payment information to the corresponding seller and storing it to a payment list;
receiving merchandise delivery authorization information transmitted from the seller and storing it to a merchandise delivery authorization list;
starting a back-stage procedure comparing the payment list and the merchandise delivery authorization list to generate a missing order message and sending the missing order message to the corresponding seller; and
receiving the awaiting merchandise delivery authorization information sent from the corresponding seller and storing it to the merchandise delivery authorization list.

2. The method of claim 1, wherein payment platform automatically starts the back-stage procedure to check any missing order regularly.

3. The method of claim 1, wherein the step of receiving merchandise delivery authorization information transmitted from the seller and storing it to a merchandise delivery authorization list further includes the step of displaying a successful trade message on the buyer's operating terminal.

4. The method of claim 1, wherein the step of receiving the awaiting merchandise delivery authorization information sent from the corresponding seller operating terminal and storing it to the merchandise delivery authorization list further includes the step of displaying a successful trade message on the buyer's operating terminal.

5. A system of processing missing orders in E-commerce for transmitting trading messages among a plurality of buyer operating terminals, a payment platform, and a plurality of seller operating terminals on the Internet;
wherein each of the buyer operating terminals makes a payment via the payment platform, transmits a payment message to the corresponding seller operating terminal, and stores the payment message in a payment list; the payment platform receives merchandise delivery authorization information transmitted from the seller operating terminal and stores the merchandise delivery authorization information in a merchandise delivery authorization list; and the payment platform includes a back-stage procedure comparing the payment list and the merchandise delivery authorization list to generate a missing order message and sending the missing order message to the corresponding seller operating terminal until awaiting merchandise delivery authorization information is received from the corresponding seller operating terminal.

6. The system of claim 5, wherein the payment platform automatically starts the back-stage procedure to check any missing order regularly.
